(19) United States
(12) Patent Application Publication
(10) Pub. No.: US 2026/0261601 A1
(43) Pub. Date: Sep. 3, 2026

(54) SYSTEMS AND METHOD TO ENHANCE SESSION OFFLOADING DURING FAILOVER IN HIGH AVAILABILITY (HA) ENVIRONMENT

(71) Applicant: Fortinet, Inc., Sunnyvale, CA (US)

(72) Inventors: Bojia Qiu, Burnaby (CA); Frank Pan, Burnaby (CA); Guoyi Yan, Sunnyvale, CA (US); Yong Wang, Burnaby (CA)

(73) Assignee: Fortinet, Inc., Sunnyvale, CA (US)

(21) Appl. No.: 19/066,640

(22) Filed: Feb. 28, 2025

(51) Int. Cl. H04L 67/148; H04L 67/1095; H04L 67/141; H04L 69/40

(52) U.S. Cl. CPC H04L 67/148; H04L 67/1095; H04L 67/141; H04L 69/40

(57) ABSTRACT

A computer-implemented method includes establishing sessions in a first network appliance initially having a primary role for processing network traffic having data packets, upon sessions being established in the first network appliance, offloading of relevant session information for a simultaneous synchronizing process of the relevant session information to a second network appliance initially having a secondary role, and concurrent with the synchronization process, offloading the relevant session information to one or more network processing resources of the second network appliance to ensure that offloaded sessions of the one or more network processing resources are ready to be used on the second network appliance if a Failover process is initiated from the first network appliance to the second network appliance.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2025, Fortinet, Inc.

### Field

Embodiments discussed generally relate to systems and methods for enhancing session offloading from a first network appliance to a second network appliance before and during failover in a high availability (HA) environment.

### BACKGROUND

Network appliances each equipped with Network Processing Unit (NPU) support and operating in High Availability (HA) mode, encountered significant challenges when managing millions of concurrent sessions. Initially, sessions are processed on a first network appliance having a primary role and offloaded to its NPU. However, during a HA Failover, these sessions are picked up by a second network appliance that is transitioning to a primary role, requiring the sessions to be offloaded to a NPU of the second network appliance within a short period. This simultaneous offloading of a large number of sessions during Failover puts an immense strain on CPUs of the network appliances and leads to traffic loss when the network appliances reach capacity limits.

### SUMMARY

Various embodiments provide systems and methods for enhancing session offloading from a first network appliance to a second network appliance before and during failover in a high availability (HA) environment. A computer-implemented method includes establishing sessions in a first network appliance initially having a primary role for processing network traffic having data packets, upon sessions being established in the first network appliance, offloading of relevant session information for a simultaneous synchronizing process of the relevant session information to a second network appliance initially having a secondary role, and concurrent with the synchronization process, offloading the relevant session information to one or more network processing resources of the second network appliance to ensure that offloaded sessions of the one or more network processing resources are ready to be used on the second network appliance if a Failover process is initiated from the first network appliance to the second network appliance.

In some embodiments, a system comprises one or more processing resources and a non-transitory computer readable medium coupled to the one or more processing resources and having stored therein instructions being executable by the one or more processing resources cause the one or more processing resources to establish sessions in a first network appliance initially having a primary role for processing network traffic having data packets, upon sessions being established in the first network appliance, perform a synchronizing process to offload relevant session information for the sessions to a second network appliance initially having a secondary role, and concurrent with the synchronization process, offload the relevant session information to one or more network processing resources of the second network appliance to ensure that offloaded sessions of the one or more network processing resources are ready to be used on the second network appliance if a Failover process is initiated from the first network appliance to the second network appliance.

This summary provides only a general outline of some embodiments. Many other objects, features, advantages, and other embodiments will become more fully apparent from the following detailed description, the appended claims and the accompanying drawings and figures.

### BRIEF DESCRIPTION OF THE DRAWINGS

A further understanding of the various embodiments may be realized by reference to the figures which are described in remaining portions of the specification. In the figures, similar reference numerals are used throughout several drawings to refer to similar components. In some instances, a sub-label consisting of a lower-case letter is associated with a reference numeral to denote one of multiple similar components. When reference is made to a reference numeral without specification to an existing sub-label, it is intended to refer to all such multiple similar components.

FIG. 1 illustrates a network architecture 100 having a first configuration with enhanced session offloading before and during failover in accordance with some embodiments;

FIG. 2 illustrates a network architecture 200 having a second configuration with enhanced session offloading before and during failover in accordance with some embodiments;

FIG. 3 illustrates a flow diagram showing a computer-implemented method 300 in accordance with some embodiments for enhanced session offloading before and during a failover process;

FIG. 4 illustrates exemplary functional modules of a network device 400 (e.g., one or more network processors, one or more NPUs 212a, 212b, etc.) that can perform session offloading on behalf of a variety of one or more processing resources (e.g., 211a, 211b) of a network appliance in accordance with some embodiments; and

FIG. 5 illustrates an example of a computer system in accordance with some embodiments.

### DETAILED DESCRIPTION

Various embodiments provide systems and methods for enhancing session offloading from a first network appliance to a second network appliance before and during failover in a high availability (HA) environment.

Embodiments of the present disclosure include various processes, which will be described below. The processes may be performed by hardware components or may be embodied in machine-executable instructions, which may be used to cause a general-purpose or special-purpose processor programmed with the instructions to perform the steps. Alternatively, processes may be performed by a combination of hardware, software, firmware and/or by human operators.

Embodiments of the present disclosure may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

In the following description, numerous specific details are set forth in order to provide a thorough understanding of embodiments of the present disclosure. It will be apparent to one skilled in the art that embodiments of the present disclosure may be practiced without some of these specific details.

### Terminology

Brief definitions of terms used throughout this application are given below.

The terms “connected” or “coupled” and related terms, unless clearly stated to the contrary, are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

As used herein, a “network appliance” or a “network device” generally refers to a device or appliance in virtual or physical form that is operable to perform one or more network functions. In some cases, a network appliance may be a database, a network server, or the like. Some network devices may be implemented as general-purpose computers or servers with appropriate software operable to perform one or more network functions. Other network devices may also include custom hardware (e.g., one or more custom Application-Specific Integrated Circuits (ASICs)). Based upon the disclosure provided herein, one of ordinary skill in the art will recognize a variety of network appliances that may be used in relation to different embodiments. In some cases, a network appliance may be a “network security appliance” or a network security device” that may reside within the particular network that it is protecting, or network security may be provided as a service with the network security device residing in the cloud. Such network security devices may include, but are not limited to, network firewall devices and/or network gateway devices. While there are differences among network security device vendors, network security devices may be classified in three general performance categories, including entry-level, mid-range, and high-end network security devices. Each category may use different types and forms of central processing units (CPUs), network processors (NPs), network processing units (NPUs), and content processors (CPs). NPs and NPUs may be used to accelerate traffic by offloading network traffic from the main processor. CPs may be used for security functions, such as flow-based inspection and encryption. Entry-level network security devices may include a CPU and no co-processors or a system-on-a-chip (SoC) processor that combines a CPU, a CP and an NP or NPU. Mid-range network security devices may include a multi-core CPU, a separate NP Application-Specific Integrated Circuits (ASIC), and a separate CP ASIC. At the high-end, network security devices may have multiple NPs or NPUs, and/or multiple CPs. A network security device is typically associated with a particular network (e.g., a private enterprise network) on behalf of which it provides the one or more security functions. Non-limiting examples of security functions include authentication, next-generation firewall protection, antivirus scanning, content filtering, data privacy protection, web filtering, network traffic inspection (e.g., secure sockets layer (SSL) or Transport Layer Security (TLS) inspection), intrusion prevention, intrusion detection, denial of service attack (DoS) detection and mitigation, encryption (e.g., Internet Protocol Secure (IPSec), TLS, SSL), application control, Voice over Internet Protocol (VoIP) support, Virtual Private Networking (VPN), data leak prevention (DLP), antispam, antispyware, logging, reputation-based protections, event correlation, network access control, vulnerability management, and the like. Such security functions may be deployed individually as part of a point solution or in various combinations in the form of a unified threat management (UTM) solution. Non-limiting examples of network security appliances/devices include network gateways, VPN appliances/gateways, UTM appliances (e.g., the FORTIGATE family of network security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), network access control appliances (e.g., FORTINAC family of network access control appliances), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), virtual or physical sandboxing appliances (e.g., FORTISANDBOX family of security appliances), and DoS attack detection appliances (e.g., the FORTIDDOS family of DoS attack detection and mitigation appliances).

The phrase “processing resource” is used in its broadest sense to mean one or more processors capable of executing instructions. Such processors may be distributed within a network environment or may be co-located within a single network appliance. Based upon the disclosure provided herein, one of ordinary skill in the art will recognize a variety of processing resources that may be used in relation to different embodiments.

Example embodiments will now be described more fully hereinafter with reference to the accompanying drawings, in which exemplary embodiments are shown. This disclosure may, however, be embodied in many different forms and should not be construed as limited to the embodiments set forth herein. It will be appreciated by those of ordinary skill in the art that the diagrams, schematics, illustrations, and the like represent conceptual views of processes illustrating systems and methods embodying various aspects of the present disclosure. The functions of the various elements shown in the figures may be provided through the use of dedicated hardware as well as hardware capable of executing associated software and their functions may be carried out through the operation of program logic, through dedicated logic, through the interaction of program control and dedicated logic.

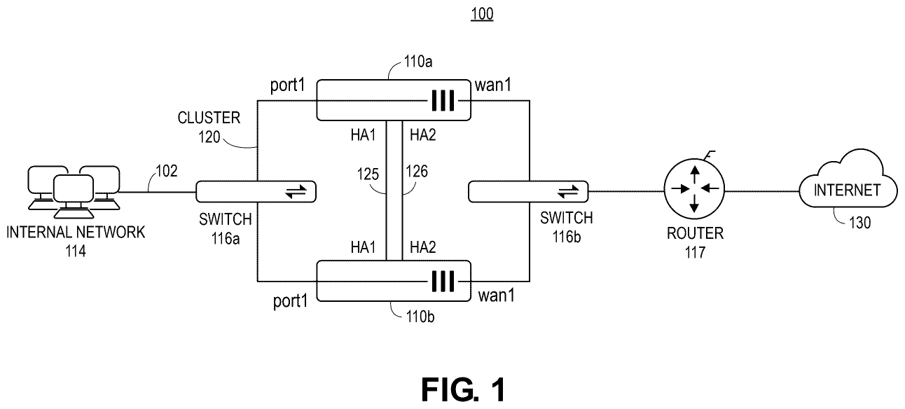

Turning to FIG. 1, a network architecture 100 with enhanced session offloading before and during failover is shown in accordance with some embodiments. In the context of network architecture 100, a number of network elements (e.g., a network element/switch 116a, a network element/switch 116b, router 117) are coupled to a local internal network 114. Local internal network 114 may be any type of communication network known in the art. Those skilled in the art will appreciate that local network 114 can be wireless network, a wired network, or a combination thereof that can be implemented as one of the various types of networks, such as an Intranet, a Local Area Network (LAN), a Wide Area Network (WAN), an Internet, and the like. Further, local network 114 can either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like.

Access to local network 114 is controlled by network security appliances 110a and 110b of a cluster 120. In some embodiments, network security appliances 110a and 110b each include hardware circuitry (e.g., one or more central processing units (CPUs), one or more network processors, one or more network processing units (NPU), memory, etc.) that can be configured for enhancing session offloading between network appliances 110a and 110b before and during failover in a high availability (HA) environment.

Traditionally sessions are solely managed and offloaded by a kernel to a NPU on the network appliance 110a that initially has a primary role for processing network traffic. This network architecture 100 of the present disclosure allows a network appliance 110b that initially has a secondary role (e.g., no receiving of network traffic and no processing of network traffic) to actively participate in session management to be ready for a primary role before a Failover occurs. The network appliance 110b actively participates in session management before Failover in case the network appliance 110b transitions to a primary role for processing network traffic.

When sessions are established in the network appliance 110a, relevant session offloading related information is simultaneously synchronized to network appliance 110b from network appliance 110b. Session offloading related information can include inbound device, outbound device, npu id, npu device id, NPU Security Association, sequence numbers, and routing information, which are important for maintaining session continuity and security.

Concurrent with the synchronization process before a Failover from network appliance 110a to network appliance 110b, the network appliance 110b begins offloading these sessions to one or more NPUs of the network appliance 110b. This is done to ensure that NPU sessions are ready to be used on network appliance 110b in the event of a Failover, thus bypassing the need for kernel processing on the network appliance 110b. Upon a Failover event in which the network appliance 110b transitions to the primary role, the network appliance 110b can utilize the pre-offloaded sessions in its NPU right away to avoid any delay from kernel processing.

Communication network 102 may be any type of communication network known in the art. Those skilled in the art will appreciate that, each of communication network 102 can be wireless network, a wired network, or a combination thereof that can be implemented as one of the various types of networks, such as an Intranet, a Local Area Network (LAN), a Wide Area Network (WAN), an Internet 130, and the like. Further, communication network 102 can either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like.

High availability (HA) is usually required in a system where there is high demand for little downtime. There are usually hot-swaps, backup routes, or standby backup units and as soon as the active entity fails, backup entities will start functioning. This results in minimal interruption for the users.

In one example configuration of the network architecture 100, a FortiGate Clustering Protocol (FGCP) is a proprietary HA solution whereby network appliances 110a, 110b (e.g., FortiGates) can find other member network appliances to negotiate and create a cluster. A network appliance HA cluster includes at least two network appliances (members) configured for HA operation. In one example, the network appliances in the cluster are the same model and have the same firmware installed. Cluster members may also have the same or similar hardware configuration (e.g., same number of hard disks). Cluster members can share the same configurations except for their host name and priority in the HA settings. The cluster works like a device but always has a hot backup device (network appliance).

Members use heartbeat connections and interfaces to communicate information (e.g., configuration information, session information, etc.) with each other. In general, a two-member cluster is most common though a cluster can include two or more members. Double back-to-back heartbeat connections 125 and 126 are illustrated in FIG. 1. The FortiGate's HA Heartbeat listens on certain ports (e.g., TCP/703, TCP/23, or ETH Layer 2/8890).

FGCP provides failover protection if an active device loses power or if a monitored interface loses a connection. After failover occurs, the user will not notice any difference, except that the active device has changed.

FGCP uses a combination of incremental and periodic synchronization to make sure that the configuration of all cluster units/members is synchronized to that of the primary unit having a primary role. FGCP can have normal data traffic or IPSec traffic in a high availability environment.

### Failover Protection

Before triggering a failover if a link fails, an administrator must ensure that monitor interfaces are configured. Normally, the internal interface that connects to the internal network, and an outgoing interface for traffic to the internet or outside the network, should be monitored. Any of those links going down will trigger a failover.

When an active (primary role) unit loses power, a backup (secondary role) unit automatically becomes the active, and the impact on traffic is minimal.

A HA failover can also be triggered by a solid state drive (SSD) failure of a network appliance.

A HA failover can also be triggered when memory utilization exceeds a threshold for a specific amount of time. Memory utilization is checked at a configured sample rate. If the utilization is above the threshold every time that it is sampled for the entire monitor period, then a failover is triggered.

If a network appliance (e.g., member, unit) of the cluster meets the memory utilization conditions to cause failover, but the last memory triggered failover happened within the timeout period, then the failover does not occur. Other HA cluster members can still trigger memory based failovers if these members meet the criteria and have not already failed within the timeout period.

After a memory based failover from network appliance 110a to network appliance 110b, if the memory usage on network appliance 110a goes down below the threshold but the memory usage on network appliance 110b is still below the threshold, then a failover is triggered, and network appliance 110a becomes the primary device.

When you disable memory based failover, a new HA primary selection occurs to determine the primary device.

In one example, FGCP assigns virtual MAC addresses to each primary unit interface in an HA cluster. Virtual MAC addresses are in place so that, if a failover occurs, the new primary unit interfaces will have the same MAC addresses as the failed primary unit interfaces. If the MAC addresses were to change after a failover, the network would take longer to recover because all attached network devices would have to learn the new MAC addresses before they could communicate with the cluster. If a cluster is operating in Transparent mode, FGCP assigns a virtual MAC address for the primary unit management IP address. Since an admin can connect to the management IP address from any interface, all of the FortiGate interfaces appear to have the same virtual MAC address.

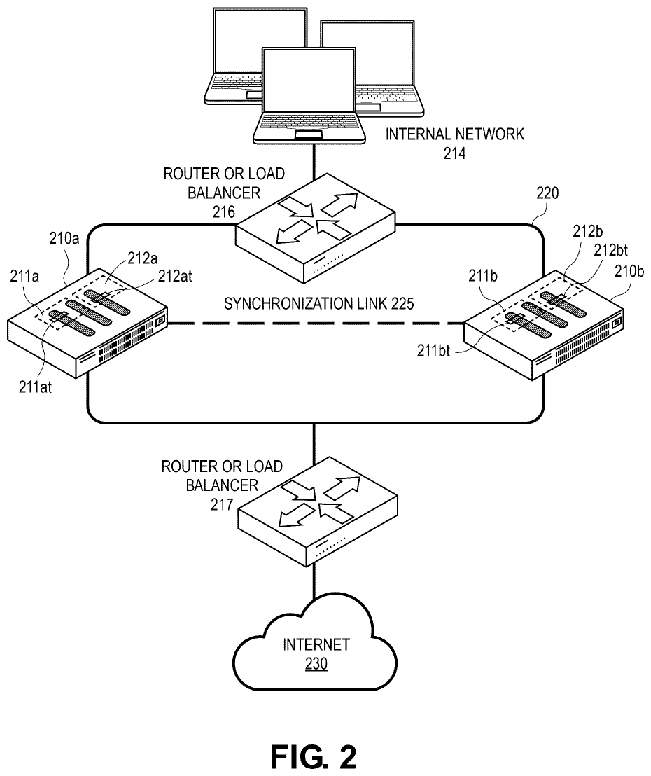

FIG. 2 illustrates a network architecture 200 with enhanced session offloading before and during failover in accordance with some embodiments. In the context of network architecture 200, a number of network elements (e.g., a network router/load balancer 216, a network router/load balancer 217) are coupled to a local internal network 214. Local network 214 may be any type of communication network known in the art. Those skilled in the art will appreciate that local network 214 can be wireless network, a wired network, or a combination thereof that can be implemented as one of the various types of networks, such as an Intranet, a Local Area Network (LAN), a Wide Area Network (WAN), an Internet 230, and the like. Further, local network 214 can either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like.

Access to local network 214 is controlled by network security appliances 210a and 210b of a cluster 220. In some embodiments, network security appliances 210a and 210b each include hardware circuitry (e.g., one or more processing resources 211a, 211b (or central processing unit (CPU) 211a, 211b), one or more network processors, one or more network processing units (NPU) 212a, 212b, memory, etc.) that can be configured for enhancing session offloading between network appliances 210a and 210b before and during failover in a high availability (HA) environment.

This network architecture 200 allows a network appliance 210b that initially has a secondary role (e.g., no receiving of network traffic and no processing of network traffic for a secondary role) to actively participate in session management to be ready for a primary role before a Failover occurs. The network appliance 210b actively participates in session management before Failover in case the network appliance 210b becomes primary for processing network traffic.

A Session Life Support Protocol (FGSP) distributes sessions between two network entities, which could be standalone FortiGates or an FGCP cluster, and performs session synchronization. If one of the peers fails, session failover occurs and active sessions fail over to the peer device that is still operating. This failover occurs without any loss of data. Also, the external routers or load balancers will detect the failover and re-distribute all sessions to the peer that is still operating. FGSP has been expanded to include both IPv4 and IPv6 TCP, UDP, ICMP, expectation, NAT sessions, and IPsec tunnels. FGSP can be configured for normal data traffic or IPSec traffic in a high availability environment.

Standalone FortiGates or FGCP clusters can be integrated into the load balancing configuration using the FGSP in a network where traffic is load balanced by an upstream load balancer and scanned by downstream network appliances. FGSP can perform session synchronization of IPv4 and IPv6 TCP, SCTP, UDP, ICMP, expectation, RSSO authenticated user logon information, and NAT sessions to keep session tables 211at, 212at, 211bt, and 212bt synchronized on all entities. If one of the network appliances fails, the upstream load balancer should detect the failed network appliance and stop distributing sessions to the network appliance. Session failover occurs and active sessions fail over to the peer devices that are still operating. Traffic continues to flow on the new peer without data loss because the sessions are synchronized.

The network appliances in FGSP operate as peers that process traffic and synchronize sessions. An FGSP deployment can include two to 16 standalone network appliances, or two to 16 network appliances FGCP clusters of two members each. Adding more network appliances increases the CPU and memory required to keep all of the network appliances synchronized, and it increases network synchronization traffic. Exceeding the numbers of members is not recommended and may reduce overall performance. By default, FGSP synchronizes all IPv4 and IPv6 TCP sessions, and IPsec tunnels. An administrator can optionally add filters to control which sessions are synchronized, such as synchronizing packets from specific source and destination addresses, source and destination interfaces, or services.

The session synchronization link 225 is an optional configuration that allows peers to synchronize sessions over a dedicated interface instead of the interface in which the peer IP is routed. In this configuration, communications occur over Layer 2 instead of Layer 3. Configuring session synchronization links is recommended when you want to minimize traffic over the peering interface when there are many sessions that need to be synchronized.

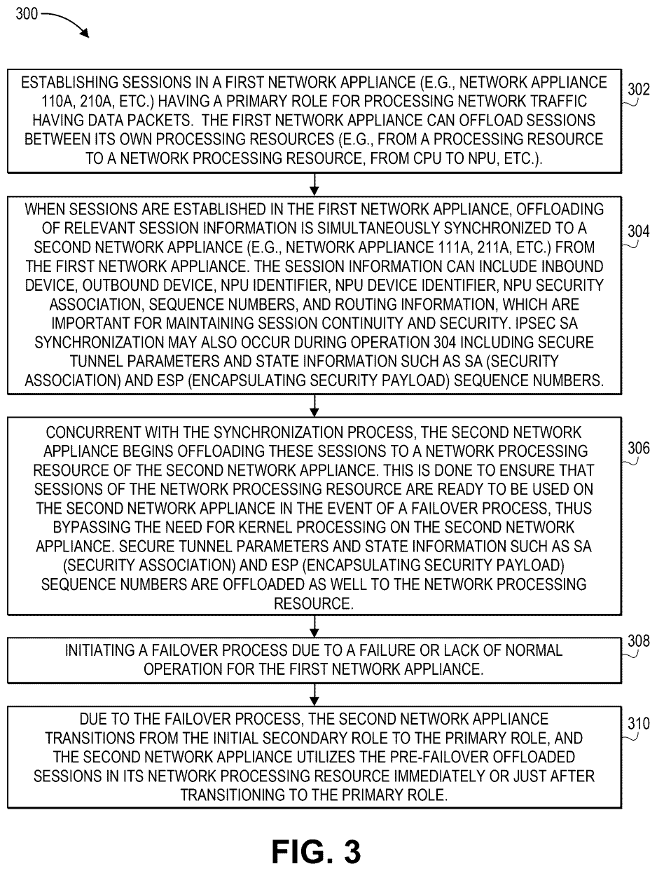

Turning to FIG. 3, a flow diagram shows a computer-implemented method 300 in accordance with some embodiments for enhanced session offloading before and during a failover process. The operations for the blocks of the method 300 can be performed by one or more processing resources (e.g., one or more processors, one or more CPUs, one or more NPUs, one or more network processing resources, etc.) of a network security appliance/device including a network gateway, a VPN appliance/gateway, or UTM appliance (e.g., the FORTIGATE family of network security appliances). Two or more network appliances can be configured as part of a cluster (e.g., FGCP high availability cluster, FGSP high availability cluster, etc.). In one example, a first network appliance initially has a primary role and a second network appliance initially has a secondary role.

At operation 302, the computer-implemented method includes establishing sessions in a first network appliance (e.g., network appliance 110a, 210a, etc.) having a primary role for processing network traffic having data packets. The first network appliance can offload sessions between its own processing resources (e.g., from a processing resource to a network processing resource, from CPU to NPU, etc.). When sessions are established in the first network appliance, at operation 304, relevant session offloading of related session information is simultaneously synchronized with a communication link to a second network appliance (e.g., network appliance 110b, 210b, etc.) from the first network appliance. The session information can include inbound device, outbound device, NPU identifier, NPU device identifier, NPU Security Association, sequence numbers, and routing information, which are important for maintaining session continuity and security. IPSec SA synchronization may also occur during operation 304 including secure tunnel parameters and state information such as SA (Security Association) and ESP (Encapsulating Security Payload) sequence numbers. The first network appliance does not send packet data to the second network appliance during the relevant session offloading of related session information.

Concurrent with the synchronization process, at operation 306, the second network appliance begins offloading these sessions to one or more network processing resources (e.g., NP, NPU, etc.) of the second network appliance. This is done to ensure that sessions of the one or more network processing resources are ready to be used on the second network appliance in the event of a Failover, thus bypassing the need for kernel processing on the second network appliance.

Secure tunnel parameters and state information such as SA (Security Association) and ESP (Encapsulating Security Payload) sequence numbers are offloaded as well in operation 306. This ensures that encrypted traffic remains uninterrupted and secure during Failover.

As previously discussed, a Failover event can occur due to various issues including a network link failure, a power failure, a SSD failure, or memory utilization above a threshold for a network appliance.

At operation 308, a Failover process is initiated due to a failure or lack of normal operation for the first network appliance. Due to the Failover process, at operation 310, the second network appliance transitions from the initial secondary role to the primary role, and the second network appliance utilizes the pre-Failover offloaded sessions in its one or more network processing resources (e.g., one or more NPUs, one or more NPs) immediately or just after transitioning to the primary role. Therefore, network traffic can continue to be processed with minimal interruption and without an additional CPU overhead of re-offloading from the CPU to the NPU of the second network appliance.

Routing and Role Management: IKE (Internet Key Exchange) routes are synchronized with specific route tags, enabling dynamic route adjustments post-Failover. Role transitions between IKE master and slave are managed seamlessly, ensuring continuous security negotiations and traffic flow.

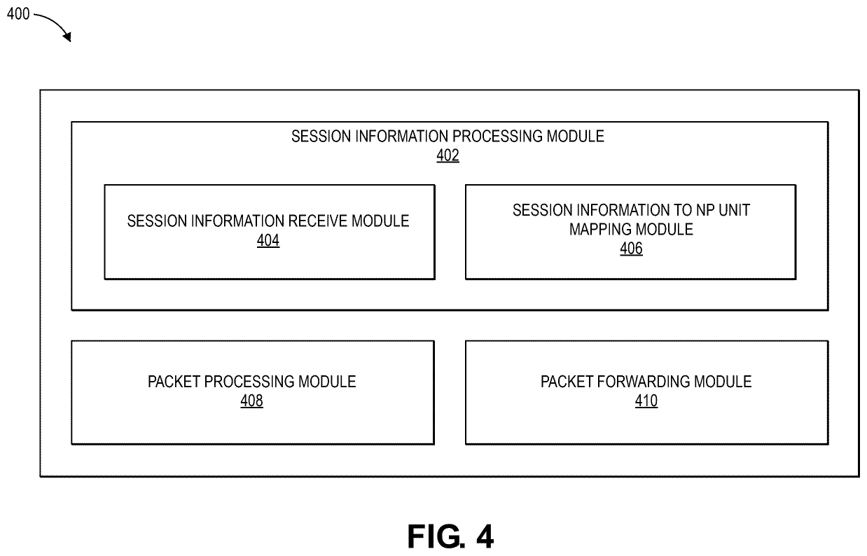

FIG. 4 illustrates exemplary functional modules of a network device 400 (e.g., one or more network processing resources, one or more NPUs 212a, 212b, etc.) that can perform session offloading on behalf of a variety of one or more processing resources (e.g., 211a, 211b) of a network appliance in accordance with some embodiments. In the context of the present example, the network device 400 includes a session information processing module 402 for receiving session information offloaded by one or more processing resources (e.g., 211a, 211b) of a network appliance and maintaining a mapping of sessions to corresponding NPUs. In an exemplary implementation, session information processing module 402 can include a session information receive module 404 that can be configured to receive session information offloaded by one or more processing resources (e.g., 211a, 211b), and a session information to NP unit mapping module 206 configured to associate an offloaded session with an NPU and maintain a mapping of sessions to NPUs to which the sessions are assigned. In an exemplary implementation, network device 400 can be configured to receive session information and offloading request from any number of one or more processing resources (e.g., 211a, 211b) on behalf of which the network device 400 is configured to perform session offloading.

As those skilled in the art will appreciate, the one or more processing resources (e.g., 211a, 211b) served by network device 400 can be in virtual or physical form and include, but are not limited to firewalls, routers, gateways, network controllers, layer 3 network appliances and/or security devices or combinations thereof.

In an aspect, the session information to network processing unit (NPU) mapping module 406 can be configured to assign session information to one or more NPUs, and maintain information pertaining to the sessions assigned to the one or more NPUs. In an exemplary implementation, a CPU (not shown) of the one or more processing resources (e.g., 211a, 211b) can perform load balancing while associating a session with a particular NPU.

The network device 400 can further include a packet processing module 408 configured to receive a packet from one or more processing resources (e.g., 211a, 211b), identify a session with which the received packet is associated, determine the NPU by which the packet should be processed based on the identified session and cause the identified NPU to process the packet. In an exemplary implementation, processing of the packet can include, but is not limited to, header parsing, pattern matching, bit-field manipulation, table look-ups, packet modification and data movement.

In another aspect, network device 400 can include a packet forwarding module 410 configured to forward the processed packet towards or to a destination specified by/in the processed packet on behalf of the one or more processing resources (e.g., 211a, 211b).

In an aspect, the one or more processing resources (e.g., 211a, 211b) enable NPUs to work independent of each other. The one or more processing resources (e.g., 211a, 211b) can facilitate offloading for any physical or virtual network appliance/device of any vendor that is configured to request such offloading. In an exemplary implementation, one or more processing resources (e.g., 211a, 211b) can share a session mapping table with other one or more processing resources (e.g., 211a, 211b) so as to enable efficient forwarding.

In an exemplary implementation, one or more processing resources (e.g., 211a, 211b), upon receiving a first packet of a communication session, can determine if subsequent packets of the session are capable of being offloaded to a NPU. Offloading logic can be implemented within the one or more processing resources (e.g., 211a, 211b) so as to enable a determination of when to use NPUs for performing offloading. In an exemplary implementation, the one or more processing resources (e.g., 211a, 211b), upon making an affirmative determination that the session can be offloaded to a NPU, can send session information to the NPU through the pre-setup connection. If the one or more processing resources (e.g., 211a, 211b) determine that the session is offloadable, it can send the session information (e.g., information regarding one or more of the protocol, inbound device, outbound device, NPU identifier, NPU device identifier, NPU Security Association, sequence numbers, routing information, the source IP address, the destination IP address, the source media access control (MAC) address, the destination MAC address, the source port, the destination port, connection state information, a unique session identifier, an action to be taken, a session expiration time, details of subsequent task and next task details), to the layer 2 network device through the pre-setup connection.

Responsive to receiving the session information from the one or more processing resources (e.g., 211a, 211b), the network device 400 can associate the session with an NPU so as to manage/process subsequent packets associated with the session. The network device 400 can install/configure the session information within an NPU.

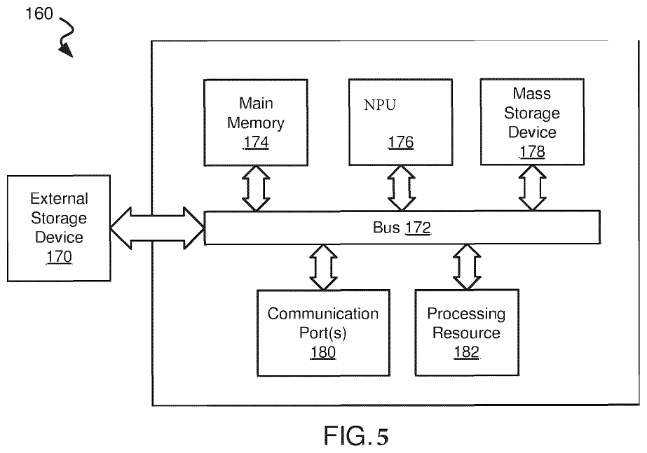

Turning to FIG. 5, an example computer system 160 is shown in which or with which embodiments may be utilized. As shown in FIG. 5, computer system 160 includes an external storage device 170, a bus 172, a main memory 174, one or more NPUs 176, a mass storage device 178 having non-transitory computer readable medium, one or more communication ports 180, and one or more processing resources 182 (e.g., processing circuitry 182, CPU(s), etc.). In one embodiment, computer system 160 may represent some portion of network security appliance 110a, 110b, 210a, and/or 210b from FIGS. 1-2.

Those skilled in the art will appreciate that computer system 160 may include more than one processing resource 182 and communication port 180. Non-limiting examples of processing resources include, but are not limited to, Intel Quad-Core, Intel i3, Intel i5, Intel i7, Apple M1, AMD Ryzen, or AMD® Opteron® or Athlon MP® processor(s), Motorola® lines of processors, FortiSOC™ system on chip processors or other future processors. Processors 182 may include various modules associated with embodiments of the present disclosure.

Communication port 180 can be any of an RS-232 port for use with a modem-based dialup connection, a 10/100 Ethernet port, a Gigabit, 10 Gigabit, 25G, 40G, and 100G port using copper or fiber, a serial port, a parallel port, or other existing or future ports. Communication port 180 may be chosen depending on a network, such as a Local Area Network (LAN), Wide Area Network (WAN), or any network to which the computer system connects.

Memory 174 can be Random Access Memory (RAM), or any other dynamic storage device commonly known in the art. Memory 174 can include Read only memory such as any static storage device(s) e.g., but not limited to, a Programmable Read Only Memory (PROM) chips for storing static information e.g., start-up or BIOS instructions for the processing resource.

Mass storage 178 may be any current or future mass storage solution, which can be used to store information and/or instructions. Non-limiting examples of mass storage solutions include Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1300), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 172 communicatively couples processing resource(s) with the other memory, storage and communication blocks. Bus 172 can be, e.g., a Peripheral Component Interconnect (PCI)/PCI Extended (PCI-X) bus, Small Computer System Interface (SCSI), USB or the like, for connecting expansion cards, drives and other subsystems as well as other buses, such as front side bus (FSB), which connects processing resources to software systems.

Optionally, operator and administrative interfaces, e.g., a display, keyboard, and a cursor control device, may also be coupled to bus 172 to support direct operator interaction with the computer system. Other operator and administrative interfaces can be provided through network connections connected through communication port 180. External storage device 170 can be any kind of external hard-drives, floppy drives, IOMEGA® Zip Drives, Compact Disc Read Only Memory (CD-ROM), Compact Disc-Rewritable (CD-RW), Digital Video Disk Read Only Memory (DVD-ROM). Components described above are meant only to show various possibilities. In no way should the aforementioned example computer systems limit the scope of the present disclosure.

In conclusion, the present design provides for novel systems, devices, and methods. While detailed descriptions of one or more embodiments of the present design have been given above, various alternatives, modifications, and equivalents will be apparent to those skilled in the art without varying from the spirit of the present design. Therefore, the above description should not be taken as limiting the scope of the present design, which is defined by the appended claims.

What is claimed is:

1. A computer-implemented method comprising:
establishing sessions in a first network appliance initially having a primary role for processing network traffic having data packets;
upon establishing sessions in the first network appliance, offloading of relevant session information for a synchronizing process of the relevant session information to a second network appliance initially having a secondary role; and
concurrent with the synchronizing process, offloading the relevant session information to one or more network processing resources of the second network appliance to ensure that offloaded sessions of the one or more network processing resources are ready to be used on the second network appliance if a Failover process is initiated from the first network appliance to the second network appliance.

2. The computer-implemented method of claim 1, wherein the sessions of the one or more network processing resources are ready to be utilized on the second network appliance when a Failover process is initiated to bypass processing on the second network appliance due to the Failover process from the first network appliance to the second network appliance.

3. The computer-implemented method of claim 1, further comprising:
initiating a Failover process due to a failure or lack of normal operation for the first network appliance; and
transitioning an initial secondary role of the second network appliance to a primary role for receiving and processing network traffic.

4. The computer-implemented method of claim 3, further comprising:
utilizing, with the second network appliance, the offloaded sessions of the one or more network processing resources just after the second network appliance transitions to the primary role.

5. The computer-implemented method of claim 1, wherein the relevant session information comprises inbound device, outbound device, network processing resource identifier, network processing resource device identifier, sequence numbers, and routing information to maintain session continuity and security.

6. The computer-implemented method of claim 1, wherein the second network appliance receives the relevant session information to actively participate in session management prior to initiating of the Failover process.

7. The computer-implemented method of claim 1, wherein the first network appliance comprises a network security appliance or a network gateway server.

8. A system comprising:
one or more processing resources; and
a non-transitory computer readable medium coupled to the one or more processing resources and having stored therein instructions being executable by the one or more processing resources cause the one or more processing resources to:
establish sessions in a first network appliance initially having a primary role for processing network traffic having data packets;
upon establishing sessions in the first network appliance, perform a synchronizing process to offload relevant session information for the sessions to a second network appliance initially having a secondary role; and
concurrent with the synchronizing process, offload the relevant session information to one or more network processing resources of the second network appliance to ensure that offloaded sessions of the one or more network processing resources are ready to be used on the second network appliance if a Failover process is initiated from the first network appliance to the second network appliance.

9. The system of claim 8, wherein the sessions of the one or more network processing resources are ready to be utilized on the second network appliance when a Failover process is initiated to bypass processing on the second network appliance due to the Failover process from the first network appliance to the second network appliance.

10. The system of claim 8, wherein the instructions being executable by the one or more processing resources cause the one or more processing resources to:
initiate a Failover process due to a failure or lack of normal operation for the first network appliance; and
transition an initial secondary role of the second network appliance to a primary role for receiving and processing network traffic.

11. The system of claim 8, wherein the instructions being executable by the one or more processing resources cause the one or more processing resources to:
utilize, with the second network appliance, the offloaded sessions of the one or more network processing resources just after the second network appliance transitions to the primary role.

12. The system of claim 8, wherein the relevant session information comprises inbound device, outbound device, network processing resource identifier, network processing resource device identifier, sequence numbers, and routing information to maintain session continuity and security.

13. The system of claim 8, wherein the second network appliance receives the relevant session information to actively participate in session management prior to initiating of the Failover process.

14. The system of claim 8, wherein the first network appliance and the second network appliance are part of a high availability storage cluster.

15. A non-transitory computer readable medium having stored therein instructions being executable by one or more processing resources cause the one or more processing resources to:
establish sessions in a first network appliance initially having a primary role for processing network traffic having data packets;
upon establishing sessions in the first network appliance, perform a synchronizing process to offload relevant session information for the sessions to a second network appliance initially having a secondary role; and
concurrent with the synchronizing process, offload the relevant session information to one or more network processing resources of the second network appliance to ensure that offloaded sessions of the one or more network processing resources are ready to be used on the second network appliance if a Failover process is initiated from the first network appliance to the second network appliance.

16. The non-transitory computer readable medium of claim 15, wherein the sessions of the one or more network processing resources are ready to be utilized on the second network appliance when a Failover process is initiated to bypass processing on the second network appliance due to the Failover process from the first network appliance to the second network appliance.

17. The non-transitory computer readable medium of claim 15, wherein the instructions being executable by the one or more processing resources cause the one or more processing resources to:
initiate a Failover process due to a failure or lack of normal operation for the first network appliance; and
transition an initial secondary role of the second network appliance to a primary role for receiving and processing network traffic.

18. The non-transitory computer readable medium of claim 15, wherein the instructions being executable by the one or more processing resources cause the one or more processing resources to:
utilize, with the second network appliance, the offloaded sessions of the one or more network processing resources just after the second network appliance transitions to the primary role.

19. The non-transitory computer readable medium of claim 15, wherein the relevant session information comprises inbound device, outbound device, network processing resource identifier, network processing resource device identifier, sequence numbers, and routing information to maintain session continuity and security.

20. The non-transitory computer readable medium of claim 15, wherein the second network appliance receives the relevant session information to actively participate in session management prior to initiating of the Failover process.
